(19) United States
(12) Patent Application Publication
(10) Pub. No.: US 2019/0044272 A1
(43) Pub. Date: Feb. 7, 2019

(54) ELECTRICAL CONNECTOR WITH ELONGATED POSITIONING HOLE DURING MANUFACTURING AND METHOD MAKING THE SAME

(71) Applicant: FOXCONN INTERCONNECT TECHNOLOGY LIMITED, Grand Cayman, KY (US)

(72) Inventors: WEN-FANG ZHANG, Kunshan (CN); WEI ZHONG, Kunshan (CN); JIAN-KUANG ZHU, Kunshan (CN)

(21) Appl. No.: 16/055,522

(22) Filed: Aug. 6, 2018

(30) Foreign Application Priority Data
Aug. 4, 2017 (CN) 201710658373.1

(51) Int. Cl. H01R 13/502; H01R 13/516; H01R 24/62; H01R 13/405; H01R 43/20

(52) U.S. Cl. CPC H01R 13/502; H01R 13/516; H01R 43/20; H01R 13/405; H01R 24/62

(57) ABSTRACT

An electrical connector includes a contact module integrally enclosed within an insulative outer cover via an over-molding process. The outer cover includes a base and a mating tongue extending from the base. The mating tongue includes a pair of mating surfaces. The contact module includes a body located in the base and the extension extending from the body and located within the mating tongue. The body forms at least one positioning hole through which the core pin of the over-molding mold extends. The positioning hole is dimensioned/configured to have the corresponding core pin snugly restrained in the first horizontal direction while loosely confined in the second horizontal direction perpendicular to the first horizontal direction.

### BACKGROUND OF THE INVENTION

### 1. Field of the Invention

The present invention relates to an electrical connector having the corresponding contact module, and particularly to the electrical connector without molding contamination thereof during manufacturing.

### 2. Description of Related Art

The China Utility Patent Nu. 206004042 discloses an electrical connector having an insulative outer cover enclosing a contact module and a pair of metallic reinforcing pieces. The outer cover is overmolded upon the contact module and the pair of metallic reinforcing pieces to form the mating section. The contact module originally forms a pair of round positioning holes through which a pair of round core pins of the corresponding mold extend during over-molding the outer cover upon the contact module. Anyhow, because of the manufacturing tolerance of the preformed contact module, it is relatively difficult to have the mold for the over-molding correctly aligned with the contact module via the engagement between the core pin of the mold and the preformed positioning holes of the contact module in both the horizontal direction X and the horizontal direction Y which are perpendicular to each other. Therefore, it is highly possible to have the insulative outer cover applied upon the contact module and the corresponding pair of reinforcing pieces in an incorrect relative position, thus resulting in a so-called contamination.

It is desired to have an electrical connector with a new structure and/or a new manufacturing method without such a contamination defect.

### SUMMARY OF THE INVENTION

An electrical connector includes a contact module integrally enclosed within an insulative outer cover via an over-molding process. The outer cover includes a base and a mating tongue extending from the base. The mating tongue includes a pair of mating surfaces. The contact module includes a body located in the base and the extension extending from the body and located within the mating tongue. The body forms at least one positioning hole through which the core pin of the over-molding mold extends. The positioning hole is dimensioned/configured to have the corresponding core pin snugly restrained in the first horizontal direction while loosely confined in the second horizontal direction perpendicular to the first horizontal direction so as to cooperate the additional sliding mold to precisely form the insulative outer cover upon the contact module without risks of contamination.

A method of making the aforementioned electrical connector comprises the following steps: (1) providing a contact module with the base and the extension extending from the base; (2) providing the base with at least one positioning hole having an asymmetrical configuration with regard to the first horizontal direction and the second horizontal direction perpendicular to each other; (3) providing an over-molding mold with the main part moveable in the vertical direction with at least one round core pin and the sliding part moveable in the horizontal direction; (4) positioning the contact module upon the over-molding mold with the core pin extending through the positioning hole wherein the engagement between the core pin and the positioning hole is snugly restrained in the first horizontal direction while is loosely confined in the second horizontal direction; (5) adjustably moving the sliding part in the second horizontal direction to be located in the right horizontal position in the second horizontal direction and precisely aligned with the contact module in the vertical direction; (6) applying the insulative outer cover upon the contact module via the over-molding process; and removing the main part and the sliding part wherein a molding hole is formed in the outer cover aligned with the positioning hole, through both of which the core pin extends in the vertical direction during manufacturing.

Understandably, one feature of the invention is to have the preformed positioning hole in the contact module snugly restrain the core pin of the over-molding mold in the first horizontal direction while loosely confine that in the second direction along which the sliding part of the over-molding mold is moveable. Under this condition, the positioning hole may be of a round shape symmetrically configured with regard to the first horizontal direction and the second direction while the core pin of the mold is configured in an asymmetrical arranged with regard to the first horizontal direction and the second horizontal direction instead.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector according to the invention;

FIG. 2 is another perspective view of the electrical connector of FIG. 2;

FIG. 3 is an exploded perspective view of the electrical connector of FIG. 1;

FIG. 4 is another exploded perspective view of the electrical connector of FIG. 3;

FIG. 5 is an exploded perspective view to show the contact module and the pair of metallic reinforcing pieces of the electrical connector of FIG. 4;

FIG. 6 is a plan view of the contact module of the electrical connector of FIG. 5;

FIG. 7 is n exploded perspective view of the contact module of the electrical connector of FIG. 6;

FIG. 8 is another exploded perspective view of the contact module of the electrical connector of FIG. 7;

FIG. 9 is a perspective view to show the contact module in the over-molding mold used the invention;

FIG. 10 is a top view of the contact module in the over-molding mold of FIG. 9; and

FIG. 11 is a cross-sectional view of the electrical connector of FIG. 1 with the corresponding core pin of the over-molding mold extending through the corresponding positioning hole before the electrical connector is removed from the over-molding mold.

### DETAILED DESCRIPTION OF THE PREFERRED EMBODIMENT

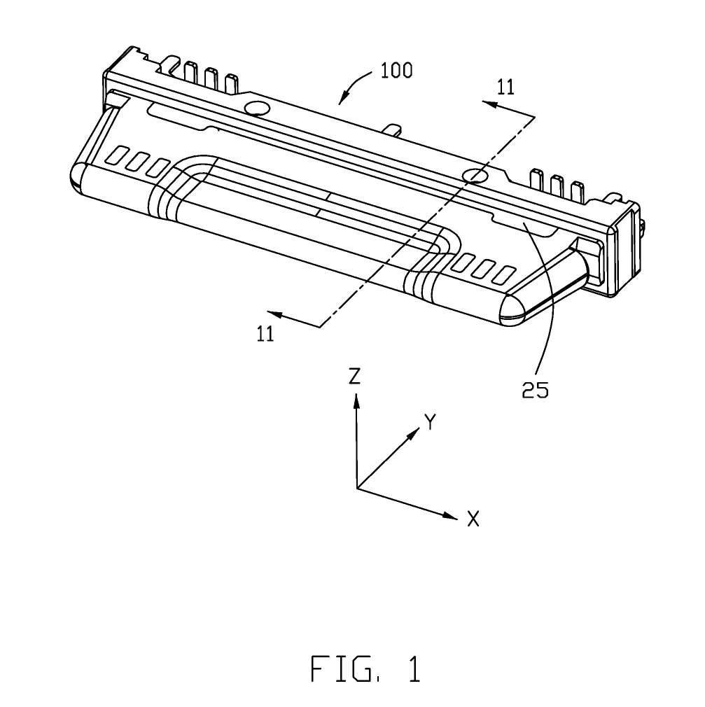

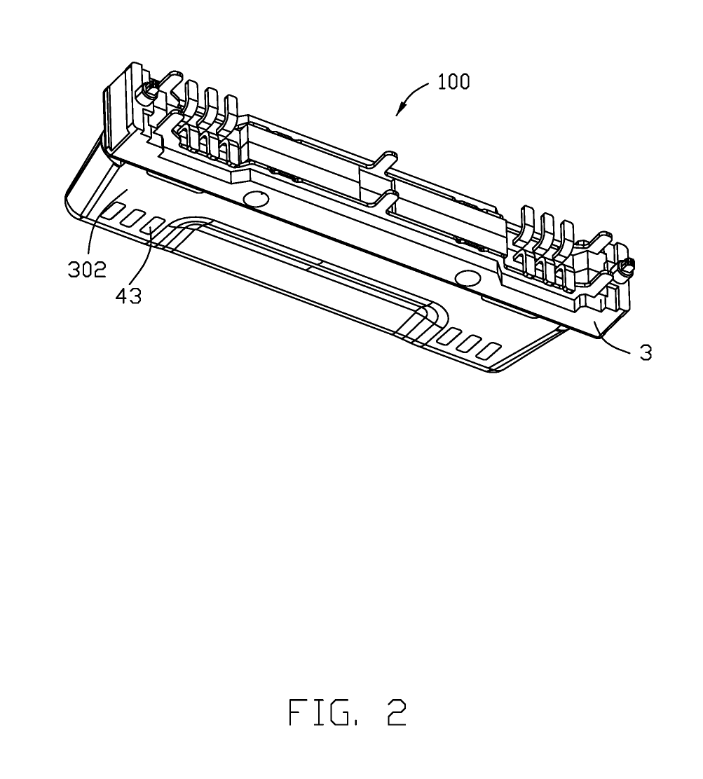

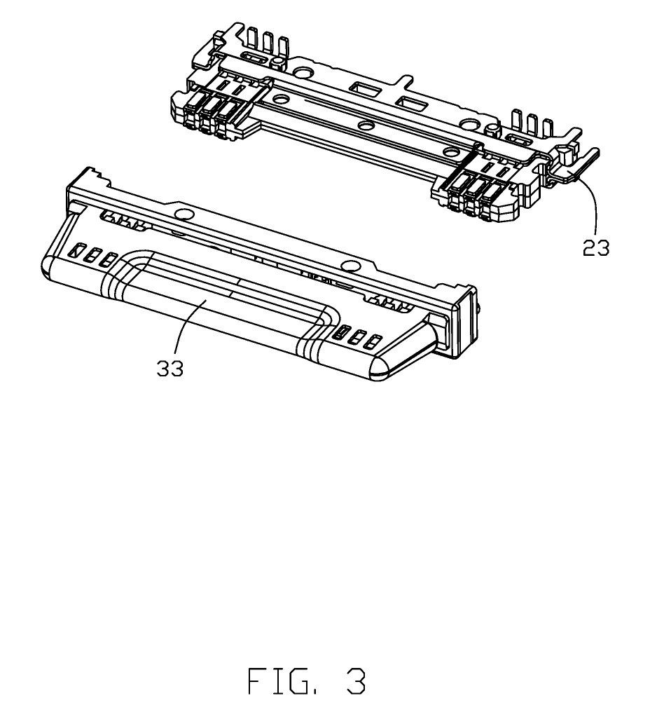

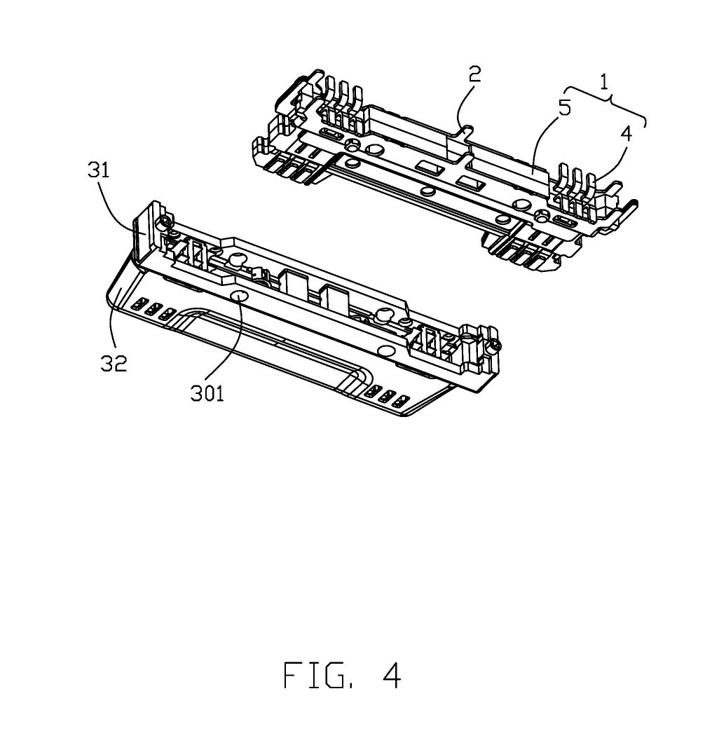

Referring to FIGS. 1-4, the electrical connector 100 includes a contact module 1, a pair of metallic reinforcing pieces 2, and an insulative outer cover 3 applied upon both the contact module 1 and the reinforcing pieces 2. The contact module 1 includes a plurality of contacts 4 and an insulative housing 5 integrally formed with the contacts 4.

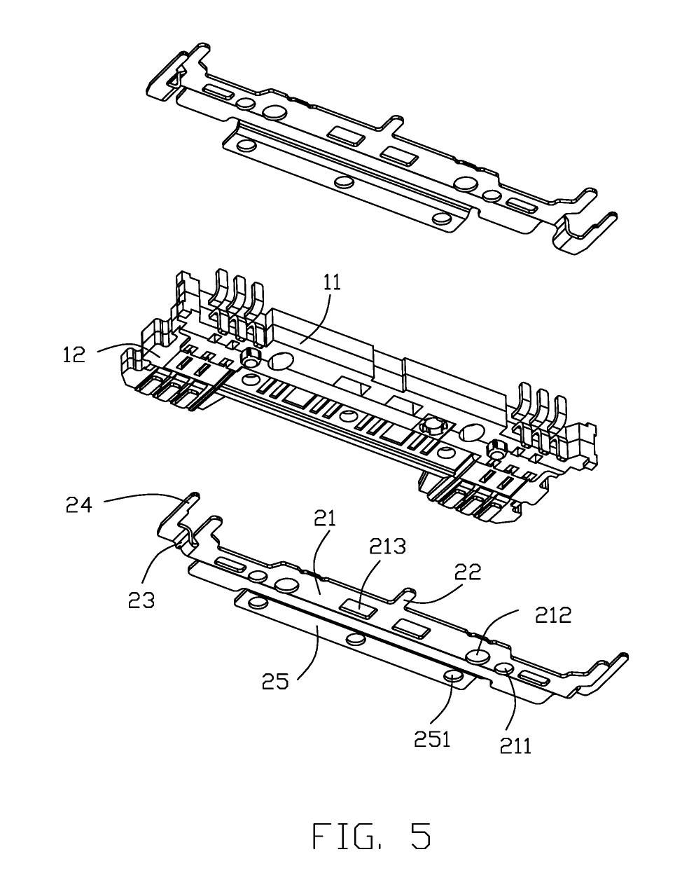

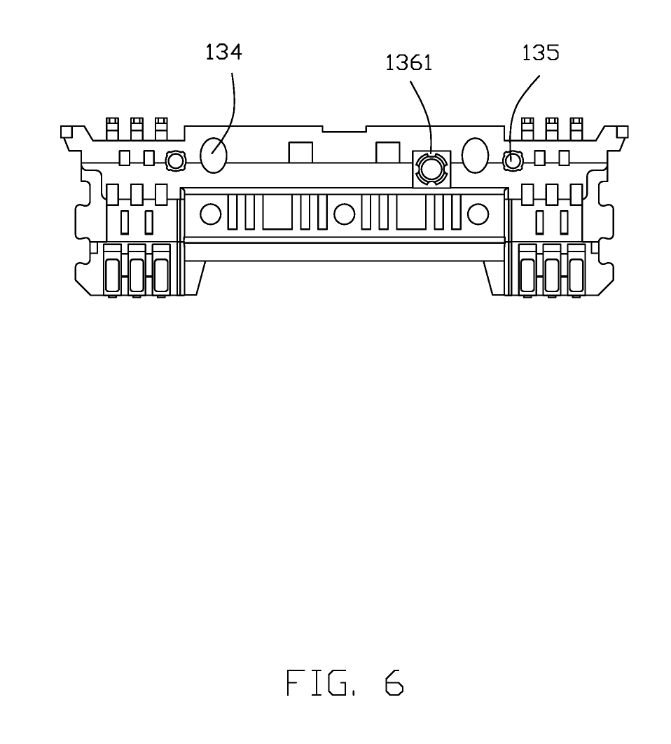

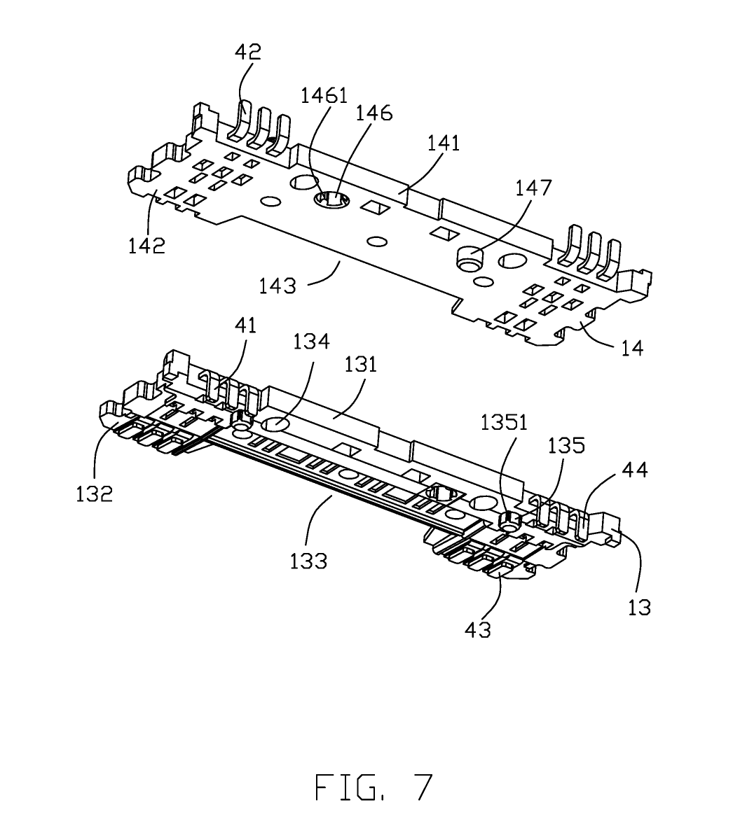

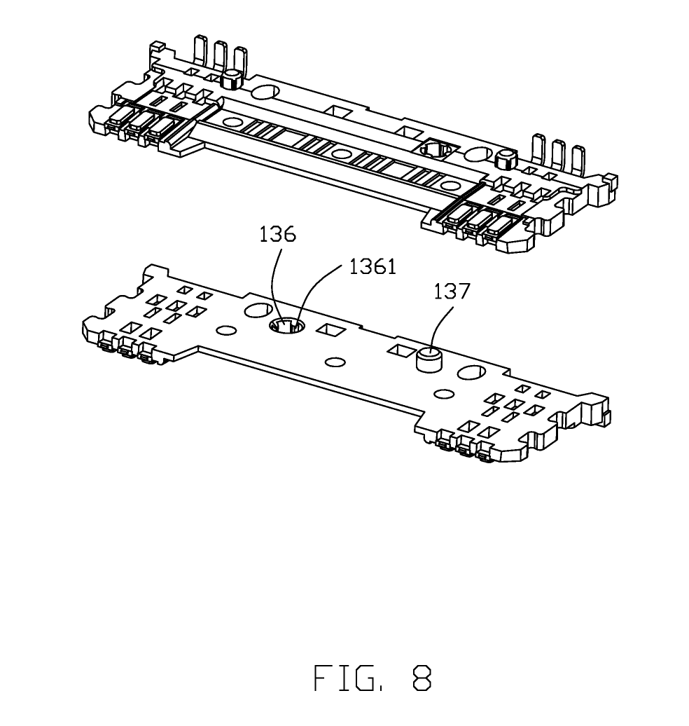

Referring to FIGS. 5-8, the contact module 1 includes a body 11 and an extension 12 extending from the body 11 along direction Y. The contact module 1 includes a first contact module/unit 13 and a second contact module/unit 14 stacked with each other in direction Z. The first contact module 13 includes a first body 131, a pair of first extensions 132 extending from the first body 131 in direction Y, and a first opening 133 between the pair of first extensions 132 in direction X. The second contact module 14 includes a second body 141, a pair of second extensions 142 extending from the second body 141 in direction Y, and a second opening 143 between the pair of second extensions 142 in direction X. The first body 131 and the second body 141 are stacked with each other in direction Z to form the body 11, and the first extensions 132 and the second extensions 142 are stacked with each other in direction Z to form the extension 12. Notably, direction X, direction Y and direction Z are perpendicular to one another. The contacts 4 include the first contacts 41 retained in the first contact module 13, and the second contacts 42 retained in the second contact module 14. Notably, each of the first contact 41 and the second contact 42 includes a retention section (not labeled) retained in the corresponding first body 131 and second body 141, a contacting section 43 exposed upon the corresponding first extension 132 and second extension 142, and a tail 44 extending out of the first body 131 and second body 141.

Notably, the first contact module 13 is essentially same with second contact module 14, so the following description is essentially exemplified with the first contact module 13 only. The first body 131 includes a pair of first positioning holes 134 extend therethrough in direction Z. A pair of fixing posts 135 for use with the reinforcing piece 2 (illustrated later) are respective located by two sides of the pair of first positioning holes 134, and a through hole 136 between the pair of first positioning holes 134. In this embodiment, the first positioning hole defines a dimension in direction Y larger than that in direction X. Specifically, in this embodiment the first positioning hole 134 is oval/elliptical. Understandably, the rectangular or capsular shape is also optional as long as an asymmetrical arrangement is performed with regard to direction X and direction Y. The fixing post 135 is round with the engagement ribs 1351. The through hole 136 extends through opposite surfaces of the first body 131 in direction Z with engagement ribs 1361 on an interior surface thereof. The first body 131 further includes a pole 137 extending through the corresponding through hole 146 of the second body 142, and correspondingly, the second body 14 includes a pole 147 extending through the corresponding hole 136 of the first body 13 so as to have the first contact module 13 and the second contact module 14 fixed together wherein the engagement ribs 1361 and 1461 may reinforce engagement with the corresponding pole 147 and 137. The first contact module 13 further forms a plurality of rectangular filling holes (not labeled) and a plurality of round filling holes (not labeled) for receiving material of the outer cover 3 during the over-molding process for enhancing retention/engagement between the contact module 1 and the outer cover 3.

The pair of metallic reinforcing pieces 2 are positioned upon two opposite surfaces of the contact module 1. Each reinforcing piece 2 includes a main body 21, a plurality of mounting legs 22 extending in direction Y. a pair of connection sections 23 at two opposite ends of the main body 21, and a pair of fixing legs 24 extending from the pair of connection sections 23 in direction Y, respectively. The main body 21 forms a pair of fixing holes 211 to receive the corresponding pair of fixing posts 135, respectively, and a pair of second positioning holes 212 which are essentially aligned with the pair of first positioning holes 134, respectively. Notably, the fixing hole 211 is round to comply with the fixing post 135. The dimension of the second positioning hole 212 may not need to be precise compared with the first positioning hole 134 which is required to be properly engaged with the corresponding core pin of the over-molding mold in direction X (illustrated later). Each reinforcing piece 2 further includes a mating region 25 opposite to the mounting legs 22 in direction Y. The reinforcing piece 2 further includes a plurality of rectangular injection holes 213 and round injection holes 215 in alignment with the corresponding aforementioned rectangular filling holes and round filling holes for allowing the outer cover 3 filling the corresponding filling holes during the over-molding process. The engagement ribs 1351 of the fixing post 135 enhance engagement of the fixing post 135 within the corresponding fixing hole 211. The corresponding fixing legs 24 of the pair of reinforcing pieces 2 are intimately stacked with each other after assembled.

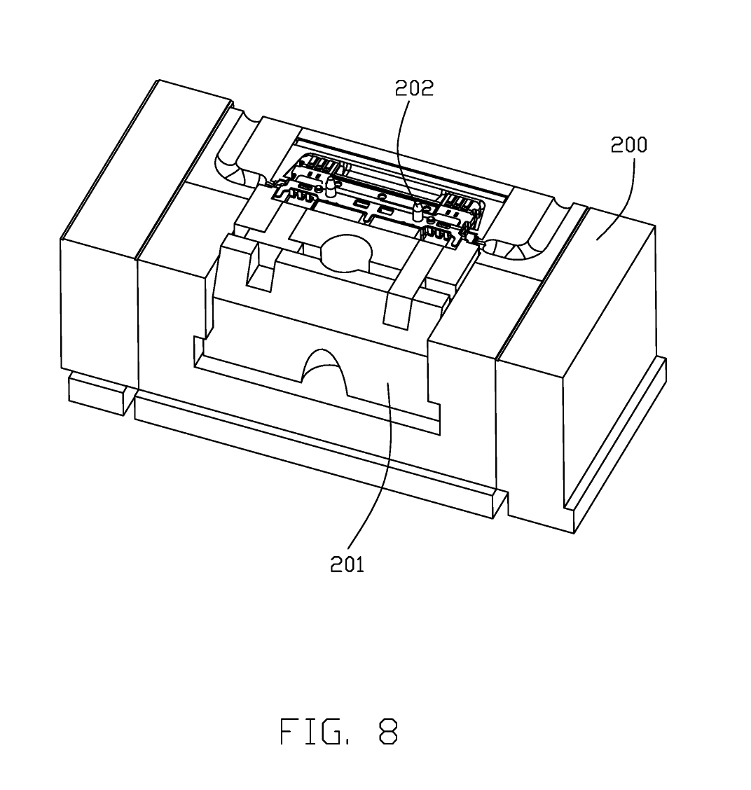

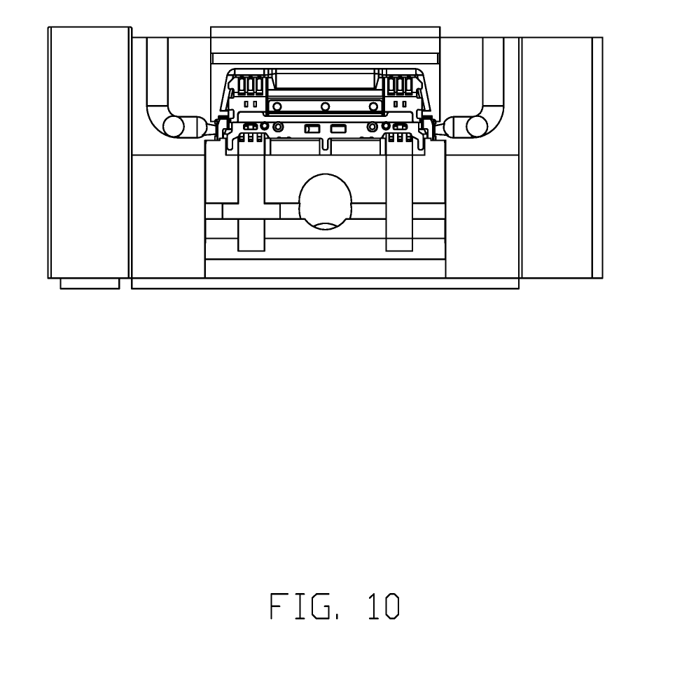

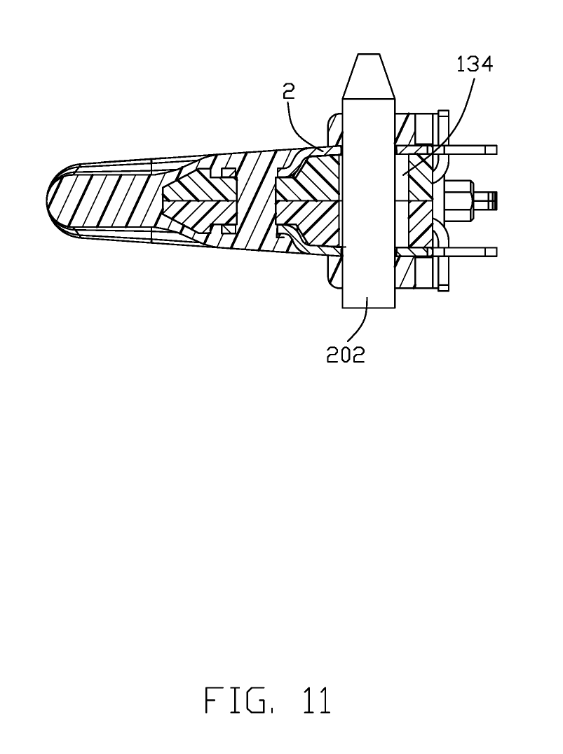

Referring to FIGS. 9-11, the contact module 1 with the pair of reinforcing pieces 2 assembled thereto, is located within the mold 200. The mold 200 includes a main part with the core pins 202 extending in direction Z, and a sliding part 201 moveable in direction Y wherein the core pin 202 extends through both the corresponding first positioning hole 134 and second positioning hole 212 so as to properly locate the contact module 1 and the pair of reinforcing pieces 2. Understandably, the core pin 202 may be round or square in a traditional way. Generally, the dimension of the core pin 202 is essentially not less than that of the first positioning hole 134 in direction X so as to have the contact module 1 snugly restrained by the mold 200 in direction X, while is essentially smaller than that of the first positioning hole 134 in direction Y so as to have the contact module loosely retained by the mold 200 in direction Y. The sliding part 201 cooperates with the core pins 202 to have the contact module 1 precisely positioned in the mold 200 in direction Y to form the outer cover 3 via the over-molding process. Understandably, the cover 3 will form the over-molding holes 301 in alignment with the corresponding first positioning hole 134 and second positioning hole 212 after removal of the core pins 202. Notably, the mating region 25 is exposed upon the mating surface 302 of the outer cover 3.

As shown in FIGS. 1-5, the outer cover 3 includes a main body 31 and a mating tongue 32 extending from the main body 31 in direction Y. The over-molding hole 301 is positioned in the main body 31. The mating surfaces 302 are formed on the mating tongue 32. The contacting sections 43 of the first contacts 41 and the second contacts 42 are exposed upon the mating surfaces 302 in a coplanar manner. The outer cover 3 forms a recess 33 in each mating surface 302 corresponding to the openings 133 and 143.

Referring to FIGS. 1-11, the method of making the electrical connector 100 includes the steps as follows.

(1) forming the first contact module 13 and the second contact module 14 with the first contacts 41 and the second contacts 42, respectively, via an insert-molding process;

(2) assembling the first contact module 13 and the second contact module 14 together in a stacked manner in vertical Z via engagement between the fixing poles 137, 147 and the corresponding through holes 136, 146, where each of the first contact module 13 and the second contact module 14 has a body 11 and an extension 12 extending from the body in direction Y, and the body 11 forms a pair of positioning holes 134 each with a dimension in direction Y larger than that in direction X;

(3) assembling a pair of metallic reinforcing pieces 2 upon two opposite surfaces of the contact module 1 via engagement between the fixing posts 135 and the corresponding fixing holes 211, respectively, wherein each of the reinforcing pieces 2 includes a pair of second positioning holes 212 in alignment with the corresponding first positioning holes 134, respectively;

(4) loading the contact module 1, which is associated with the pair of reinforcing pieces 2, into the mold 200, wherein the mold 200 has a pair of core pins 202 extending through the corresponding first positioning holes 134 and second positioning holes 212 to have the contact module 1 precisely positioned in the mold 200 in direction X while loosely arranged in direction Y;

(5) moving the sliding mold 201 in direction Y to have the contact module precisely positioned with the mold 200 in direction Y;

(6) applying an insulative outer cover 3 upon the contact module 1 and the associated reinforcing pieces 2; and

(7) removing the complete electrical connector 100 from the mold 200.

It is to be understood, however, that even though numerous characteristics and advantages of the present invention have been set fourth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the members in which the appended claims are expressed. Notably, the first positioning hole 134, the second positioning hole 212 and the over-molding hole 301 may be filled with another insulative material additionally and optionally for cosmetic consideration.

What is claimed is:

1. An electrical connector comprising:
a contact module having a plurality of contacts integrally formed within an insulative housing via an insert-molding process;
a first positioning hole formed in the contact module along a vertical direction, and defining at least a first dimension in a first horizontal direction and a second dimension in a second horizontal direction perpendicular to each other and both perpendicular to said vertical direction;
a pair of metallic reinforcing pieces securely located upon two opposite surfaces of the contact module in said vertical direction;
an insulative outer cover applied upon both the contact module and the reinforcing pieces via an over-molding process; wherein
said first positioning hole is configured to receive a core pin of a mold of said over-molding process, and said first dimension is smaller than said second dimension.

2. The electrical connector as claimed in claim 1, wherein said first positioning hole is configured to snugly restrain the core pin of the mold in the first direction while loosely retain the core pine of the mold in the second direction.

3. The electrical connector as claimed in claim 1, wherein each of said reinforcing pieces has a second positioning hole in aligned with the first positioning hole in the vertical direction.

4. The electrical connector as claimed in claim 1, wherein the contact module includes a fixing post extending through a fixing hole of the corresponding reinforcing piece.

5. The electrical connector as claimed in claim 1, wherein the contact module forms a filling hole filled by the outer cover.

6. The electrical connector as claimed in claim 5, wherein one of said reinforcing pieces forms another filling hole filled by the outer cover.

7. The electrical connector as claimed in claim 1, wherein the outer cover forms an over-molding hole in alignment with the first positioning hole in the vertical direction.

8. The electrical connector as claimed in claim 1, wherein said contact module includes a pair of contact units assembled with each other in a stacked manner in the vertical direction.

9. A method of making an electrical connector, comprising steps of:
providing a contact module with a plurality of contacts integrally formed within an insulative housing via an insert-molding process wherein a first positioning hole is formed in the housing in a vertical direction to define a first dimension in a first horizontal direction perpendicular to the vertical direction, and a second dimension in a second horizontal direction perpendicular to both said vertical direction and said first horizontal direction;
assembling a pair of metallic reinforcing pieces upon two opposite surfaces of the contact module in said vertical direction;
providing a mold for an over-molding process with a core pin extending in the vertical direction;
loading the contact module with the associated reinforcing pieces with a core pin extending through the first positioning hole in the vertical direction; wherein
by the first positioning hole, the core pin is snugly restrained in the first horizontal direction while loosely retained in the second horizontal direction.

10. The method as claimed in claim 9, wherein said mold further includes a sliding part moveable in the second horizontal direction to adjust a position of the contact module with regard to the mold in the second horizontal direction.

11. The method as claimed in claim 9, further including a step of applying an insulative outer cover upon the contact module and the associated reinforcing pieces via the over-molding process.

12. The method as claimed in claim 11, wherein at least one of the reinforcing pieces forms a second positioning hole in alignment with the first positioning hole in the vertical direction.

13. The method as claimed in claim 12, wherein the outer cover forms an over-molding hole in alignment with the first positioning hole and the second positioning hole in the vertical direction.

14. The method as claimed in claim 9, wherein the first dimension is smaller than the second dimension.

15. The method as claimed in claim 14, wherein the core pin has a same dimension in both the first horizontal direction and the second horizontal direction.

16. An arrangement for making a complete electrical connector via an over-molding process, comprising:
a contact module including a plurality of contacts integrally formed within an insulative housing via an insert-molding process;
a first positioning hole formed in the housing and extending in a vertical direction;
a pair of metallic reinforcing pieces securely located upon two opposite surfaces of the contact module in said vertical direction;
a mold for said over-molding process, including a core pin extending through said first positioning hole in the vertical direction; wherein
said pin is snugly restrained in the first positioning hole in a first horizontal direction while being loosely retained therein in a second horizontal direction so as to allow the contact module to be slight moveable with regard to the mold in the second horizontal direction, said first horizontal direction and said second horizontal direction being perpendicular not only to each other but also both to the vertical direction.

17. The arrangement as claimed in claim 16, wherein the first positioning hole has a first dimension in the first horizontal direction, and a second dimension in the second horizontal direction, said first dimension being smaller than the second dimension.

18. The arrangement as claimed in claim 16, where said core pin defines a same dimension along both the first horizontal direction and the second horizontal direction.

19. The arrangement as claimed in claim 16, wherein said mold further includes a sliding part moveable along the second horizontal direction for adjusting a position of the contact module with regard to the mold in the second horizontal direction.

20. The arrangement as claimed in claim 16, further including an insulative outer cover applied upon the contact module via said over-molding process, wherein said outer cover forms an over-molding hole in alignment with the first positioning hole in the vertical direction.
